(19) United States
(12) Patent Application Publication
(10) Pub. No.: US 2023/0369581 A1
(43) Pub. Date: Nov. 16, 2023

(54) HIGH-ENTROPY TRANSITION METAL LAYERED OXIDES, POSITIVE ELECTRODE MATERIAL, AND SODIUM ION BATTERY

(71) Applicant: National Tsing Hua University, Hsinchu City (TW)

(72) Inventors: Chia-Ching Lin, Hsinchu City (TW); Jin-Wei Kang, Hsinchu City (TW); Han-Yi Chen, Hsinchu City (TW)

(73) Assignee: National Tsing Hua University, Hsinchu City (TW)

(21) Appl. No.: 17/858,979

(22) Filed: Jul. 6, 2022

(30) Foreign Application Priority Data
May 12, 2022 (TW) 111117917

(51) Int. Cl. H01M 4/525; H01M 4/505; H01M 10/054

(52) U.S. Cl. CPC H01M 4/525; H01M 4/505; H01M 10/054; H01M 2004/028

(57) ABSTRACT

A high-entropy transition metal layered oxide is an O3 type high-entropy transition metal layered oxide which is represented by the following formula (1):

Na[NiₐFe_{b}Mn_{c}M1_{d}M2ₑ]O₂ (1).

In the formula (1), M1 and M2 are selected from a group consisting of V, Cr, Co, Cu, Zn, and Ti, a+b+c+d+e=1, 0.05≤a≤0.35, 0.05≤b≤0.35, 0.05≤c≤0.35, 0.05≤d≤0.35, and 0.05≤e≤0.35.

### CROSS-REFERENCE TO RELATED APPLICATION

This application claims the priority benefit of Taiwan application serial no. 111117917, filed on May 12, 2022. The entirety of the above-mentioned patent application is hereby incorporated by reference herein and made a part of this specification.

### BACKGROUND

### Technical Field

The disclosure relates to a high-entropy oxide technology, and particularly relates to a high-entropy transition metal layered oxide, application thereof to a positive electrode material, and a sodium ion battery including the positive electrode material.

### Description of Related Art

With the rapid development in the fields of renewable energy, electric vehicles, etc., the demand for energy storage systems with high energy density and power density is increasing.

A sodium ion battery has the advantages of high energy density, low self-discharge, fast charge and discharge, and long cycle life, and the production cost is lower than that of a lithium ion battery. Therefore, the sodium ion battery is advantageous in cost as energy storage equipment. In order to improve the performance of the sodium ion battery, the development of positive electrode materials is crucial to increasing the electrochemical properties of the sodium ion battery.

However, the conventional layered oxide tends to have irreversible structural changes during the reaction process when used as the positive electrode material for the sodium ion battery, which results in poor cycle life.

### SUMMARY

The disclosure provides a high-entropy transition metal layered oxide, which is suitable as a positive electrode material of a sodium ion battery.

The disclosure further provides a positive electrode material of a sodium ion battery, which has good structural stability and excellent cycle stability.

The disclosure further provides a sodium ion battery, which includes the positive electrode material.

A high-entropy transition metal layered oxide according to the disclosure is an O3 type high-entropy transition metal layered oxide represented by the following formula (1):

Na[NiₐFe_{b}Mn_{c}M1_{d}M2ₑ]O₂ (1).

In the formula (1), M1 and M2 are selected from a group consisting of V, Cr, Co, Cu, Zn, and Ti, a+b+c+d+e=1, 0.05≤a≤0.35, 0.05≤b≤0.35, 0.05≤c≤0.35, 0.05≤d≤0.35, and 0.05≤e≤0.35.

In an embodiment of the disclosure, the O3 type high-entropy transition metal layered oxide includes Na[Ni_{0.2}Fe_{0.2}Mn_{0.2}Cu_{0.2}Ti_{0.2}]O₂, Na[Ni_{0.2}Fe_{0.2}Mn_{0.2}Co_{0.2}Ti_{0.2}]O₂, Na[Ni_{0.2}Fe_{0.2}Mn_{0.2}Cu_{0.2}Co_{0.2}]O₂ or Na[Ni_{0.3}Fe_{0.2}Mn_{0.2}Cu_{0.1}Ti_{0.2}]O₂.

In an embodiment of the disclosure, M1 and M2 in the formula (1) are Cu and Ti.

In an embodiment of the disclosure, in the formula (1), 0.2≤a≤0.35.

In an embodiment of the disclosure, M1 in the formula (1) is Cu, and 0.05≤d≤0.2.

In an embodiment of the disclosure, a surface of the O3 type high-entropy transition metal layered oxide is coated with carbon.

In an embodiment of the disclosure, the O3 type high-entropy transition metal layered oxide is synthesized by a sol-gel method, a co-precipitation method, a solid-phase sintering method or a hydrothermal method.

A positive electrode material of a sodium ion battery according to the disclosure includes: the above-described high-entropy transition metal layered oxide, a conductive agent, and a binder.

In another embodiment of the disclosure, a content of the high-entropy transition metal layered oxide is 70 wt. % to 95 wt. %, a content of the conductive agent is 2 wt. % to 15 wt. %, and a content of the binder is 2 wt. % to 15 wt. %.

A sodium ion battery according to the disclosure includes: a positive electrode, a negative electrode, a separator, and an electrolyte. The positive electrode includes the above-described positive electrode material, and the separator is between the positive electrode and the negative electrode.

Based on the above, the disclosure adopts the transition metal-containing high-entropy layered oxide (HEO) as the positive electrode material, and the HEO is synthesized by a sol-gel method, so that the precursors can be mixed at the atomic level and synthesized to obtain a uniform transition metal oxide that shows the high-entropy effect. Since the high-entropy effect can form multiple transition metals into a single-phase oxide, it can be applied to the sodium ion battery positive electrode material to form the positive electrode material with good structural stability and excellent cycle stability. Furthermore, the capacity and reaction potential of the sodium ion battery can be controlled by adjusting the element ratio.

In order to make the above-mentioned and other features and advantages of the disclosure more comprehensible, exemplary embodiments are described in detail with reference to the accompanying drawings as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 shows X-ray diffraction (XRD) patterns of the products of Preparation Examples 1 to 4.

FIG. 2 shows scanning electron microscope (SEM) images of the products of Preparation Examples 1 to 4.

FIG. 3 is an exploded view of the button battery used in the experiment of the disclosure.

FIG. 4 shows charts of constant-current charge and discharge of the half batteries including the electrodes of Preparation Examples 1 to 4.

FIG. 5 is a chart of a charge and discharge cycle test of the half batteries including the electrodes of Preparation Examples 1 to 4.

FIG. 6 is a chart of a charge and discharge cycle test of the half battery including the electrode of Preparation Example 3 at different charge and discharge rates.

FIG. 7 is a chart of a charge and discharge cycle test of the half battery including the electrode of Preparation Example 3 at 0.5 C.

FIG. 8 is a chart of constant-current charge and discharge of the sodium ion full battery including the electrode of Preparation Example 3 at different charge and discharge rates.

FIG. 9 is a chart of a charge and discharge cycle test of the sodium ion full battery including the electrode of Preparation Example 3 at different rates.

### DETAILED DESCRIPTION OF DISCLOSED EMBODIMENTS

The following provides different embodiments for implementing different features of the disclosure. However, these embodiments are only exemplary and are not intended to limit the scope and application of the disclosure.

A high-entropy transition metal layered oxide according to an embodiment of the disclosure is an O3 type high-entropy transition metal layered oxide represented by the following formula (1).

Na[NiₐFe_{b}Mn_{c}M1_{d}M2ₑ]O₂ (1).

In the formula (1), M1 and M2 are selected from a group consisting of V, Cr, Co, Cu, Zn, and Ti, a+b+c+d+e=1, 0.05≤a≤0.35, 0.05≤b≤0.35, 0.05≤c≤0.35, 0.05≤d≤0.35, and 0.05≤e≤0.35.

In an embodiment, in the formula (1), 0.2≤a≤0.35.

In an embodiment, if M1 in the formula (1) is Cu, 0.05≤d≤0.2.

The O3 type high-entropy transition metal layered oxide may be synthesized by a sol-gel method, and the obtained high-entropy transition metal oxide has a uniform distribution of elements and presents a layered structure. In addition, the surface of the O3 type high-entropy transition metal layered oxide may be coated with carbon through surface modification to increase electrical conductivity. However, the disclosure is not limited thereto, and the O3 type high-entropy transition metal layered oxide may also be synthesized by a co-precipitation method, a solid-phase sintering method, a hydrothermal method, etc.

In an embodiment, M1 and M2 in the formula (1) are selected from the group consisting of Co, Cu, and Ti. In this embodiment, the above-described O3 type high-entropy transition metal layered oxide may be but not limited to Na[Ni_{0.2}Fe_{0.2}Mn_{0.2}Cu_{0.2}Ti_{0.2}]O2, Na[Ni_{0.2}Fe_{0.2}Mn_{0.2}Cu_{0.2}C_{0.2}]O₂, Na[Ni_{0.3}Fe_{0.2}Mn_{0.2}Cu_{0.1}Ti_{0.2}]O₂ or Na[Ni_{0.2}Fe_{0.2}Mn_{0.2}Co_{0.2}Ti_{0.2}]O₂. In a preferred embodiment, the above-described O3 type high-entropy transition metal layered oxide is Na[Ni_{0.2}Fe_{0.2}Mn_{0.2}Cu_{0.2}Ti_{0.2}]O₂ or Na[Ni_{0.3}Fe_{0.2}Mn_{0.2}Cu_{0.1}Ti_{0.2}]O₂.

A positive electrode material according to another embodiment of the disclosure includes the above-described high-entropy transition metal layered oxide, a conductive agent, and a binder. In the positive electrode material, the content of the high-entropy transition metal layered oxide is, for example, 70 wt. % to 95 wt. %, and may be 75 wt. % to 85 wt. %; the content of the conductive agent is, for example, 20 wt. % or less, and may be 2 wt. % to 15 wt. %; and the content of the binder is, for example, 20 wt. % or less, and may be 2 wt. % to 15 wt. %.

The conductive agent may be but not limited to: graphite, carbon black, carbon fiber, carbon nanotube, acetylene black, meso carbon micro beads (MCMB), graphene or a combination thereof.

The binder may be but not limited to: styrene-butadiene rubber latex (SBR), carboxymethyl cellulose (CMC), polyvinylidene difluoride (PVDF), polyimide, acrylic resin, butyral resin, polytetrafluoroethylene latex (PTFE), polyacrylate (PAA) or a combination thereof.

A sodium ion battery according to yet another embodiment of the disclosure basically includes a positive electrode, a negative electrode, a separator, and an electrolyte, wherein the positive electrode includes the above-described positive electrode material, and the separator is between the positive electrode and the negative electrode.

Experiments as follows are provided to verify the effects of implementation of the disclosure, but the disclosure is not limited to the following.

Preparation Example 1: Na[Ni_{0.2}Fe_{0.2}Mn_{0.2}Cu_{0.2}Ti_{0.2}]O₂ was synthesized by a sol-gel method.

First, Ni(NO₃)₂·6H₂O, Fe(NO₃)₃·9H₂O, Mn(NO₃)₂·4H₂O, Cu(NO₃)₂·2.5H₂O, and C₁₂H₂₈O₄Ti with a molar ratio of Ni:Fe:Mn:Cu:Ti of 1:1:1:1:1 were prepared as the precursors (total weight is 12.16 g). Then, all the precursors were added to 40 ml of deionized water and mixed, and then added to a solution containing 11.64 g of citric acid (C₆H₈O₇) and 30 ml of deionized water to obtain a mixed solution.

Then, the mixed solution was heated to 80° C., and 9.5 ml of ammonia water (NH₄OH) and 13.42 ml of ethylene glycol (C₂H₄(OH)₂) were added to form a hydrogel. After being dried, NaNO₃ was added and mixed, and ground into powder, which was then calcined at 480° C. for 6 hours. The calcined powder was pressed into an ingot and then sintered at a high temperature of 850° C. for 12 hours. The sintered ingot was ground into Na[Ni_{0.2}Fe_{0.2}Mn_{0.2}Cu_{0.2}Ti_{0.2}]O₂ powder.

Preparation Example 2: Na[Ni_{0.2}Fe_{0.2}Mn_{0.2}Cu_{0.2}Co_{0.2}]O₂ was synthesized by a sol-gel method.

The processes were the same as in Preparation Example 1 except for that C₁₂H₂₈O₄Ti was changed to Co(NO₃)₂·6H₂O.

Preparation Example 3: Na[Ni_{0.3}Fe_{0.2}Mn_{0.2}Cu_{0.1}Co_{0.2}]O₂ was synthesized by a sol-gel method.

The processes were the same as in Preparation Example 1 except for that the molar ratio of Ni:Fe:Mn:Cu:Ti was changed to 1.5:1:1:0.5:1.

Preparation Example 4: Na[Ni_{0.2}Fe_{0.2}Mn_{0.2}Co_{0.2}Ti_{0.2}]O₂ was synthesized by a sol-gel method.

The processes were the same as in Preparation Example 1 except for that Cu(NO₃)₂·2.5H₂O was changed to Co(NO₃)₂·6H₂O.

### Structural Analysis

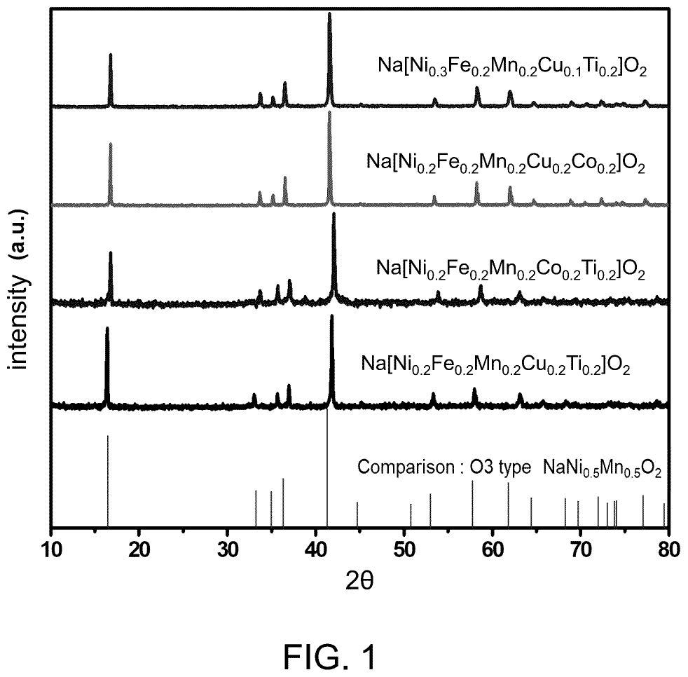

1. X-ray diffraction (XRD) analysis was performed on the products of Preparation Examples 1 to 4, and the results are shown in FIG. 1. According to FIG. 1, the high-entropy transition metal oxide of the disclosure synthesized by the sol-gel method is an O3 type high-entropy transition metal oxide.

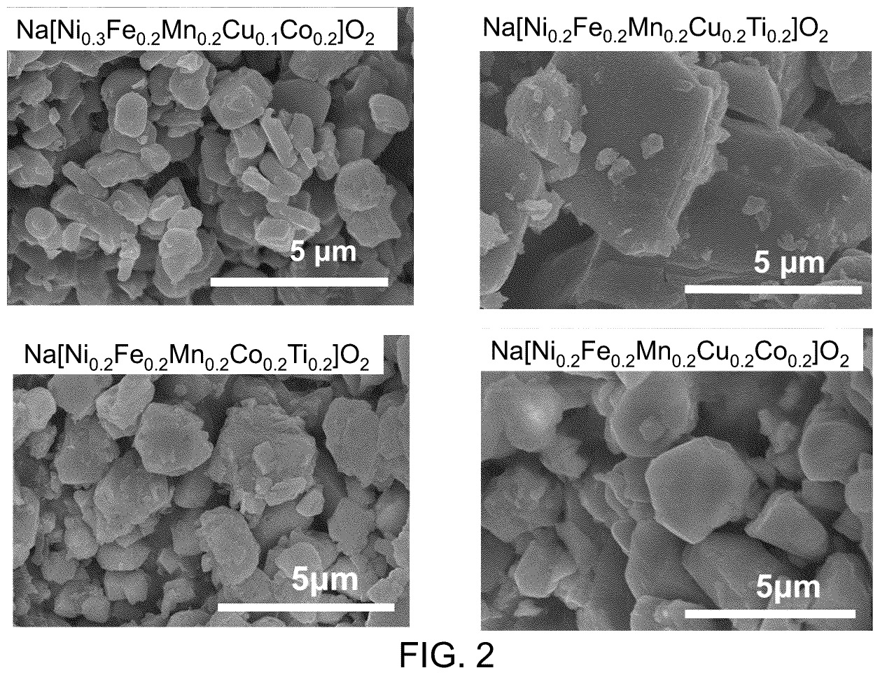

2. SEM analysis was performed on the products of Preparation Examples 1 to 4, and the results are shown in FIG. 2. According to FIG. 2, the high-entropy transition metal oxide of the disclosure synthesized by the sol-gel method has a flake-shaped layered structure and is uniformly dispersed, with a particle size of about 1 μm to 5 μm.

### Manufacture of Button Battery

First, the products of Preparation Examples 1 to 4 were respectively mixed and ground with carbon black, and then added to a PVDF solution (6 wt. % PVDF was dissolved in NMP solvent) and mixed, wherein a weight ratio of the products of Preparation Examples 1 to 4, carbon black, and PVDF is 80:10:10.

The above mixtures were coated on aluminum foil (thickness 20 μm) with a doctor blade, and dried (80° C.), rolled, and cut into slices to respectively obtain electrode plates including the products of Preparation Examples 1 to 4.

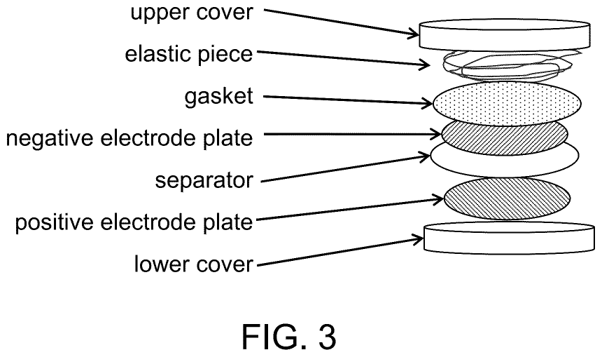

The obtained electrode plate and other components were made into the button battery as shown in FIG. 3, wherein the separator was Glassy fiber (GF/C), the positive electrode plate was the above-described electrode plate, the negative electrode plate was sodium, and the electrolyte was 1M NaClO₄ EC+PC 1:1 (volume ratio).

### Electrochemical Analysis

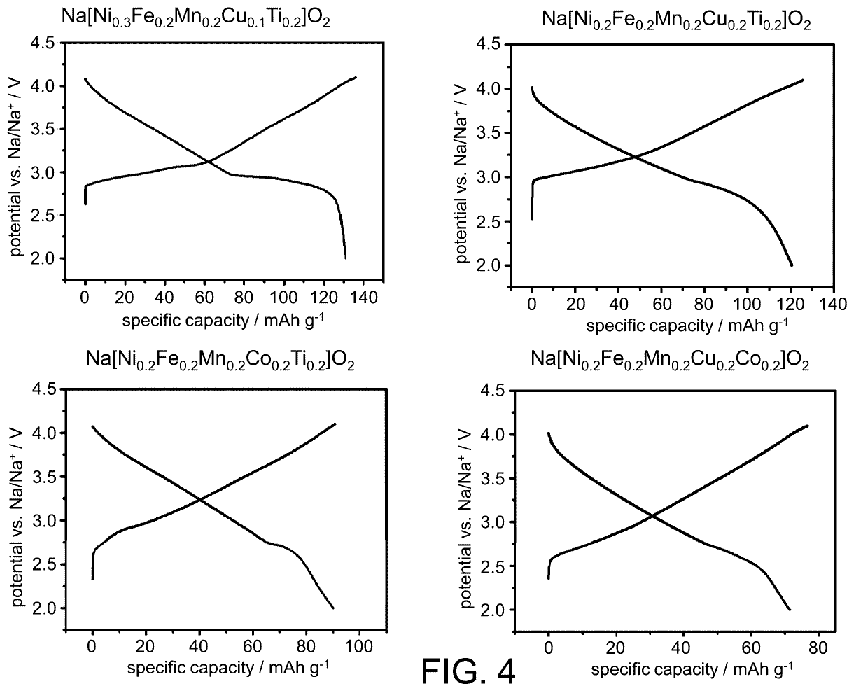

A charge and discharge test was carried out using the button batteries prepared with different positive electrode plates to obtain the constant-current charge and discharge charts of FIG. 4. It can be observed from FIG. 4 that the electrode plates respectively including the products of Preparation Examples 1 to 4 show different reaction potentials and capacity performances in the voltage range from 2 V to 4.1 V vs Na/Na⁺ with different elements added.

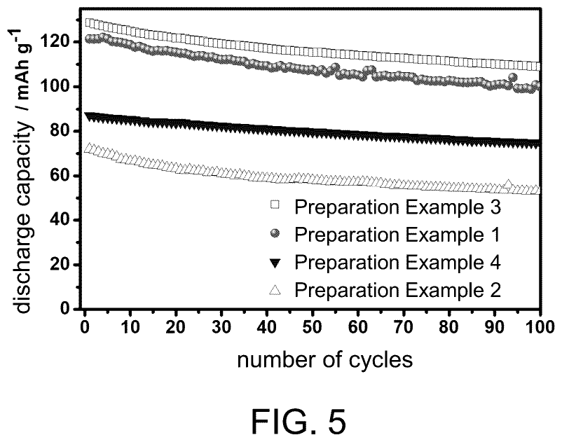

Then, under the voltage range of 2 V to 4.1 V vs Na/Na⁺ and the current density of 13 mA g⁻¹, the changes in the number of cycles and the capacities were recorded to obtain the results of FIG. 5.

It can be observed from FIG. 5 that the capacity of the button battery is between 70 mAh g⁻¹ and 130 mAh g⁻¹, and the button battery still retains 80% to 87% of the capacity retention rate after 100 cycles. Moreover, the capacities of Preparation Example 1 and Preparation Example 3 are significantly better than those of other preparation examples, indicating that the high-entropy transition metal layered oxide including Ni, Fe, Mn, Cu, and Ti has better electrochemical properties. In addition, the capacity of Preparation Example 3 is better than that of Preparation Example 1, indicating that among the high-entropy oxides including the same transition metal elements, more Ni is beneficial to the electrochemical properties; and it is presumed that less Cu prevents the copper oxide from being easily precipitated, so it is beneficial to the conductivity.

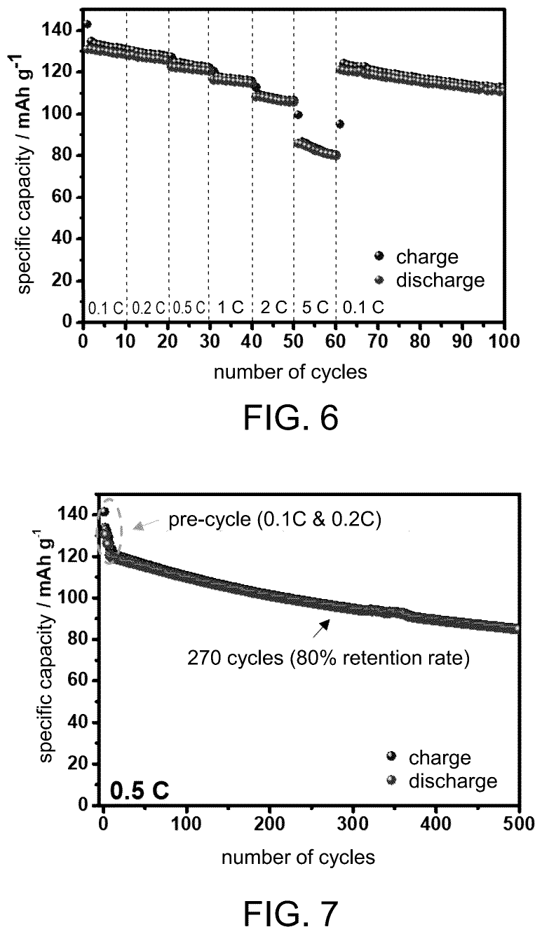

Next, a constant-current charge and discharge test was carried out using the button battery with the highest discharge capacity in FIG. 5 (the high-entropy transition metal layered oxide Na[Ni_{0.3}Fe_{0.2}Mn_{0.2}Cu_{0.1}Co_{0.2}]O₂ of Preparation Example 3) at the current densities of 13 mA g⁻¹ (0.1 C), 26 mA g⁻¹ (0.2 C), 65 mA g⁻¹ (0.5 C), 130 mA g⁻¹ (1 C), 260 mA g⁻¹ (2 C), and 650 mA g⁻¹ (5 C), and the results are shown in FIG. 6, wherein the charge capacity is slightly greater than the discharge capacity.

It can be seen from FIG. 6 that the discharge capacities obtained at different charge and discharge rates are 130 mAh g⁻¹, 129 mAh g⁻¹, 127 mAh g⁻¹, 122 mAh g⁻¹, 116 mAh g⁻¹, 108 mAh g⁻¹, and 85 mAh g⁻¹. It can be seen that the high-entropy transition metal layered oxide of Preparation Example 3 has excellent rate performance.

In addition, a 500-cycle test was carried out using the button battery including the electrode of Preparation Example 3 at the current density of 65 mA g⁻¹ (0.5 C). The results are shown in FIG. 7, wherein the charge capacity is slightly greater than the discharge capacity.

It can be observed from FIG. 7 that the button battery still retains 80% of the capacity retention rate after 270 cycles at the charge and discharge rate of 0.5 C.

### Full Battery Analysis

The positive electrode plate including the positive electrode material of Preparation Example 3 and a hard carbon negative electrode were made into a sodium ion full battery, and the other components were the same as those used in the button battery.

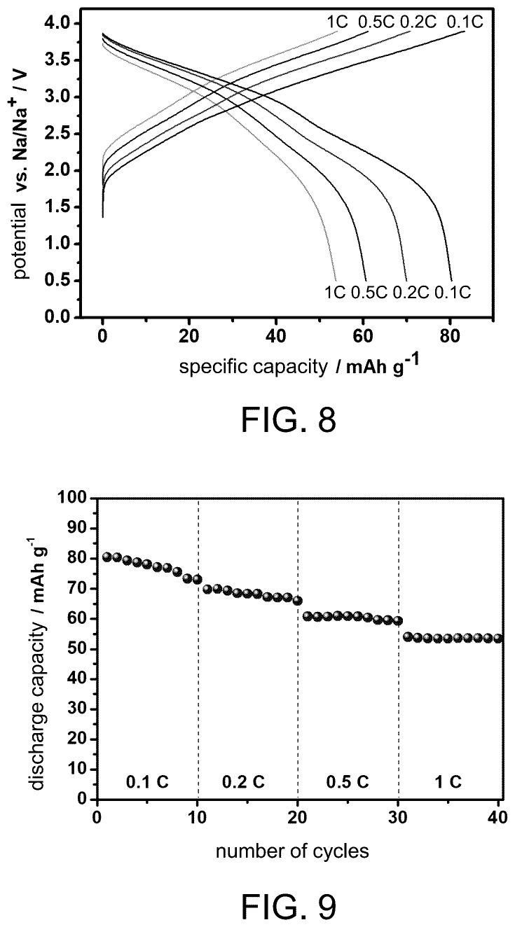

Then, a constant-current charge and discharge test was carried out at the current densities of 13 mA g⁻¹ (0.1 C), 26 mA g⁻¹ (0.2 C), 65 mA g⁻¹ (0.5 C), and 130 mA g⁻¹ (1 C) (according to the weight of the positive electrode material) in the voltage range of 0.5 V to 3.9 V to obtain FIG. 8 and FIG. 9.

It can be seen from FIG. 8 that the capacities at different charge and discharge rates are 80 mAh g⁻¹, 70 mAh g⁻¹, 60 mAh g⁻¹, and 53 mAh g⁻¹, and the measured energy densities are 225.0 Wh kg⁻¹, 194.6 Wh kg⁻¹, 165.8 Wh kg⁻¹, and 144.2 Wh kg⁻¹, indicating that the product Na[Ni_{0.3}Fe_{0.2}Mn_{0.2}Cu_{0.1}Co_{0.2}]O₂ of Preparation Example 3 has excellent potential when used as the positive electrode of the sodium ion battery.

It can be observed from FIG. 9 that the capacity of the sodium ion full battery is between 55 mAh g⁻¹ and 80 mAh g⁻¹, and the sodium ion full battery still retains close to 70% of the capacity retention rate after 40 cycles.

To sum up, the disclosure utilizes the high-entropy effect to form multiple transition metals into a single-phase oxide, thereby forming the sodium ion battery positive electrode material with good structural stability and excellent cycle stability. Furthermore, the capacity and reaction potential can be controlled by adjusting the element ratio.

Although the disclosure has been described with reference to the embodiments above, they are not intended to limit the disclosure. Those skilled in the art can make various changes and modifications without departing from the spirit and scope of the disclosure. Therefore, the scope of protection of the disclosure is defined by the following claims.

What is claimed is:

1. A high-entropy transition metal layered oxide, which is an O3 type high-entropy transition metal layered oxide represented by following formula (1):
Na[NiₐFe_{b}Mn_{c}M1_{d}M2ₑ]O₂ (1)
wherein in formula (1), M1 and M2 are selected from a group consisting of V, Cr, Co, Cu, Zn, and Ti, a+b+c+d+e=1, 0.05≤a≤0.35, 0.05≤b≤0.35, 0.05≤c≤0.35, 0.05≤d≤0.35, and 0.05≤e≤0.35.

2. The high-entropy transition metal layered oxide according to claim 1, wherein the O3 type high-entropy transition metal layered oxide comprises Na[Ni_{0.2}Fe_{0.2}Mn_{0.2}Cu_{0.2}Ti_{0.2}]O₂, Na[Ni_{0.2}Fe_{0.2}Mn_{0.2}Co_{0.2}Ti_{0.2}]O₂, Na[Ni_{0.2}Fe_{0.2}Mn_{0.2}Cu_{0.2}Co_{0.2}]O₂ or Na[Ni_{0.3}Fe_{0.2}Mn_{0.2}Cu_{0.1}Ti_{0.2}]O₂.

3. The high-entropy transition metal layered oxide according to claim 1, wherein M1 and M2 are Cu and Ti.

4. The high-entropy transition metal layered oxide according to claim 1, wherein 0.2≤a≤0.35.

5. The high-entropy transition metal layered oxide according to claim 1, wherein M1 is Cu, and 0.05≤d≤0.2.

6. The high-entropy transition metal layered oxide according to claim 1, wherein a surface of the O3 type high-entropy transition metal layered oxide is coated with carbon.

7. The high-entropy transition metal layered oxide according to claim 1, wherein the O3 type high-entropy transition metal layered oxide is synthesized by a sol-gel method, a co-precipitation method, a solid-phase sintering method or a hydrothermal method.

8. A positive electrode material of a sodium ion battery, comprising:
the high-entropy transition metal layered oxide according to claim 1;
a conductive agent; and
a binder.

9. The positive electrode material of the sodium ion battery according to claim 8, wherein a content of the high-entropy transition metal layered oxide is 70 wt. % to 95 wt. %, a content of the conductive agent is 2 wt. % to 15 wt. %, and a content of the binder is 2 wt. % to 15 wt. %.

10. A sodium ion battery, comprising:
a positive electrode comprising the positive electrode material according to claim 8;
a negative electrode;
a separator between the positive electrode and the negative electrode; and
an electrolyte.
